(19) United States
(12) Patent Application Publication
(10) Pub. No.: US 2014/0035256 A1
(43) Pub. Date: Feb. 6, 2014

(54) VEHICLE SUSPENSION ASSEMBLY

(71) Applicant: Mikel Zubieta Andueza, Eibar (ES)

(72) Inventor: Mikel Zubieta Andueza, Eibar (ES)

(73) Assignee: FUNDACION TEKNIKER, Eibar (Guipuzcoa) (ES)

(21) Appl. No.: 13/984,515

(22) PCT Filed: Feb. 9, 2012
(86) PCT No.: PCT/ES2012/070085

§ 371 Date: Oct. 16, 2013

(51) Int. Cl. B62K 25/08; B62K 25/28

(52) U.S. Cl. CPC B62K 25/08; B62K 25/286
USPC 280/284

(57) ABSTRACT

The present invention relates to a vehicle suspension system with a chassis, with a front hydraulic cylinder (4), a rear hydraulic cylinder (5) and a first hydraulic connection (6) connecting the front hydraulic cylinder (4) and the rear hydraulic cylinder (5), as well as a first compensation chamber (7) and a second compensation chamber (8) related to one another such that a change of volume ΔV1 of a hydraulic fluid in the first compensation chamber entails a change of volume ΔV2 of a hydraulic fluid in the second compensation chamber, ΔV2=k*ΔV1, k>0. Furthermore, the system comprises a second hydraulic connection (71) connecting the front hydraulic cylinder (4) and the first compensation chamber (7), and a third hydraulic connection (81) connecting the rear hydraulic cylinder (5) and the second compensation chamber (8).

### TECHNICAL FIELD OF THE INVENTION

The invention is encompassed in the field of full suspensions, for example, for bicycles, although it is also applicable to similar vehicles, for example, a motorcycle.

### BACKGROUND OF THE INVENTION

The purpose of both the front and rear bicycle suspensions is to absorb terrain obstacles and to increase stability in rough terrain. Since the obstacles affect the wheels of the bicycle, historically each of the two degrees of freedom corresponding to a full suspension bicycle have been associated with each of the wheels, such that the front suspension is responsible for damping the impacts on the front wheel, whereas the rear suspension dampens the impacts on the rear wheel. The suspensions virtually serve to replace the rigid link between the wheels of the bicycle and the frame thereof (to which the saddle, the pedals, and the handlebar is attached) with an elastic link, such that the frame of the bicycle is provided with two degrees of freedom with respect to the axles of the wheels.

However, suspensions do not only act against uneven terrain: the forces of the cyclist, such as the forces generated by the cyclist upon pedaling or the inertia effects of the cyclist him/herself upon speeding up or braking, also activate the suspensions, which is dangerous. Pedaling is a periodic movement in which a mainly vertical oscillating force is exerted which in turn generates a simultaneous bobbing movement in both suspensions. During this movement the damper of the suspensions dissipates part of the energy generated in pedaling, which reduces pedaling efficiency, while at the same time creates an unpleasant bobbing (movement in vertical direction) of the bicycle, further reducing the pedaling efficiency. On the other hand, speeding up and slowing down the bicycle entails a pitching movement on the suspensions, entailing the compression of one of the suspensions and the extension of the other. This results in part of the force being absorbed by the suspensions while speeding up, and further causes an uncomfortable movement for the cyclist while speeding up, whereby the bicycle reactivity is worsened. Similarly, pitching involving the verticalization of the angles and the reduction of the travel available in the fork occurs due to the suspensions upon braking, negatively affecting the stability of the bicycle going downhill.

In the recent years a clear trend towards increasing the suspension travel in each of the different categories of bicycles has been observed, whereby the irregularity absorbing capacity has increased considerably, but they also increase the unwanted movements, which would make the use of the bicycle itself in several conditions uncomfortable. The new technologies developed by suspension manufacturers (pedaling platforms and differentiated compression controls at high and low speed) and frame manufacturers (suspension systems in which the interaction with the transmission and braking is made use of) for controlling unwanted movements has enabled increasing suspension travels, the evolution of these technologies being one of the main fields in the continuous improvement of bicycles by the manufacturers.

For example, different rear suspension systems designed based on an interaction between the transmission and the suspension are known in the state of the art, which by making use of the tension originated in the chain cause a loss of suspension sensitivity and the blocking of said suspension, whereby the pedaling oscillations drop; however, the impact absorbing capacity also drops at the same time. Designs of this type are disclosed, for example, in documents U.S. Pat. No. 5,553,881, U.S. Pat. No. 5,628,524, U.S. Pat. No. 6,206,397, WO-A-98/49046 and U.S. Pat. No. 7,128,329.

Blocking for the units acting as the connecting link is a common solution to prevent oscillations upon pedaling. Therefore, the bicycle neither rotates nor reacts with respect to the bumps on the terrain. In the state of the art there are also partial blockings commonly known as pedaling platforms, in which the suspensions are blocked for forces less than a certain threshold, associated with the pedaling forces, and are unblocked for greater forces associated with uneven terrain. Samples of such pedaling platforms are, for example, the solutions disclosed in U.S. Pat. No. 5,190,126 and U.S. Pat. No. 7,163,222. Another partial blocking system is that of the inertia valves, disclosed, for example, in U.S. Pat. No. 7,273,137, in which the inertia of an inner mass unblocks the suspension as the wheel is lifted when traveling over a bump.

On the other hand, US-A-2003/132602 discloses a system in which an electronic sensor detects the movement of the front suspension with respect to an obstacle and regulates the rear suspension in anticipation of the approaching obstacle.

Document U.S. Pat. No. 7,017,928 discloses a suspension system for full suspension bicycles in which the front unit and the rear unit have their own degrees of freedom but they are related to one another by means of a hydraulic or pneumatic tube. The interaction between the front and rear units is used for adjusting the different heights of saddle, front suspensions and rear suspensions, but said interaction between the units is not active during the suspension operation, neither being active in the adsorption of bumps nor upon pedaling.

Suspension systems with hydraulic connections are known in the field of motor vehicles. Examples of this type of systems are disclosed in WO-A-98/18641 and in EP-A-1426212 (corresponding to ES-A-2223205).

On the other hand, WO-A-97/29007 describes a system in which, to prevent a series of drawbacks of the bicycles of the state of the art, a connection has been provided between the front suspension and the rear suspension such that a load or movement in one of the suspensions affects the other. In one embodiment the suspensions are hydraulic cylinders and the front and rear suspensions are connected by means of a connection of two of the cylinders. Therefore, if actuating a suspension causes the ejection of the hydraulic fluid from a chamber of a cylinder of said suspension, a chamber of a hydraulic cylinder of the other suspension is filled. Both suspensions are thus hydraulically coupled. The idea seems to be achieving that whatever occurs with one of the suspensions affects the behavior of the other. WO-A-97/29007 also suggests that the coupling between the two suspensions is variable, something which can be achieved with a valve in the hydraulic system.

FIG. 1 schematically shows a conventional bicycle fork 1000 which, since it is conventional, has two parts, each in one of the fork legs. It has the following parts:
The absorption part: this part accumulates (or absorbs) the energy of the impact by means of compressing spring 1008 (or other elastic element, for example, air or another gas). The force on the left piston 1007 (viewed from the position of the cyclist) in FIG. 1 is proportional to the position thereof.
The damper part: it dissipates (or dampens) the energy of the impact in the form of heat due to the friction of the hydraulic fluid (for example, oil 1003) upon passing through one or several units of holes 1002 and 1005. The flow rate passing through the holes depends on the pressure difference at both sides of the hole which relates the force exerted by the damper part to the speed of movement. This part comprises the right piston 1001 (as seen in FIG. 1), with a first unit of holes 1002, through which the oil 1003 can pass during unit compression and extension. Furthermore, there is a compression cartridge 1004 with a plunger having a second unit of holes 1005. On the other hand, to allow the movement of the piston 1001, there is a compensation chamber 1006 which virtually contains or which is a volume of air which is compressed or extended to compensate the volume variations that occurred upon introducing the right piston 1001 in the cylinder of the fork leg. If this chamber did not exist and the cylinder was completely filled with oil the right piston 1001 would be blocked. For this reason, if any of the two units of holes 1002 and 1005 of FIG. 1 is closed, the suspension will be blocked.

The absorption part will determine the movement of the suspension and the damper will determine at what speed said movement occurs with respect to a force on the suspension, even though if the force is not maintained during the necessary time the complete movement will not be achieved. It is therefore possible to control the activity of the suspensions with damping. A low damping slightly controls the suspensions, whereby the suspensions move quickly with a long travel (convenient for when the movement of the suspensions is desirable), whereas a high damping greatly controls the suspensions, whereby the suspensions move slowly with a short travel (convenient for when the movement of the suspensions is not desirable).

The main differences between a low-end fork and a high-end fork correspond to their damping systems. In high-end forks, in addition to the main hole with regulable passage 1111 (see FIG. 2A), secondary holes 1112-1113 (see FIG. 2A) are also provided the passage of which is variable depending on pressure, for example, by means of a unit of washers, which deform under high pressures and facilitate the passage of oil. At low pressures (and speeds), the force sensitive holes 1112-1113 are closed, therefore the behavior depends on the regulable hole 1111, such that the regulation of this hole is sometimes called “low speed regulation”. At high pressures (and speeds) the flow rate through the main hole is low, but the force sensitive hole is wide and carries most of the flow rate, such that the regulation of the force for opening this hole is called “high speed regulation. FIG. 2A schematically illustrates the flow 1101 of oil through the main hole 1111, and the flow 1102 of oil through the force sensitive hole 1112. The curve 1103 in FIG. 2B depicts the ratio between the force (F) and the speed (v) for the case where only the main hole 1111 exists, the curve 1104 depicts the ratio between the force and the speed for the case where only the force sensitive hole 1112 exists, and the curve 1105 depicts the ratio between the force and the speed in the case where both holes are present. The curves 1106 and 1107 depict less restrictive regulations at low speed, whereas the curves 1108 and 1109 depict more restrictive regulations at high speed.

In general, force sensitive hole systems can only be deformed towards one side, therefore the flow in opposite direction is always blocked. Therefore two force sensitive holes are usually provided so that each regulates the high speed flow in each direction 1112 and 1113 (see FIG. 2A). Furthermore, these holes can be adjusted in a differentiated manner to vary the hydraulic behavior during compression and extension. For example, in the fork 1000 of FIG. 1, the lower passage washers of the first unit of holes 1002 can be less rigid in comparison with those of the upper part of the same unit of holes, whereby they hardly resists the flow of compressed oil in the right piston 1001 (from the upper part of the piston to the lower part). Similarly, the lower passage washers of the second unit of holes 1005 can be less rigid in comparison with those of the upper part, such that the flow of rebound oil in the compression cartridge 1004 (from the upper part of the cartridge to the lower part) is performed without much restriction. The rebound behavior (low and high speed) thus depends on the unit of holes 1002 of the right piston 1001, whereas the behavior during compression (low and high speed) is adjusted by means of the unit of holes 1005 of the compression cartridge 1004.

The operation of a conventional rear damper can be very similar to that of the fork, except that instead of having the absorption elements and damper in parallel in the respective legs they are usually concentrically arranged, as is schematically shown in FIG. 3, in which a rear damper 2000 can be observed with the piston 2001 associated with a first unit of holes 2002 and located in a cylinder containing oil 2003, the cylinder of which is surrounded by a spring 2008 pressing the piston downwards. It can be considered that the rear damper is based on the same concept as the fork but with the right leg divided into two, resulting in two cylinders attached with a tube, to later place the spring concentric thereto. The rear damper comprises a compression cartridge 2004 (which functionally corresponds to the compression cartridge 1004 of the fork), a second unit of holes 2005 (which functionally corresponds to the second unit of holes 1005 of the fork), and a compensation chamber 2006 (which functionally corresponds to the compensation chamber 1006 of the fork, except that in the case of the rear damper a floating piston is arranged between the air and the oil so that both fluids do not mix; they do not mix in the fork due to density difference).

All this is conventional and describing it in more detail is not considered necessary.

Conventional full suspension bicycles have two degrees of freedom, one per each axle and suspension element. In other words, each suspension element works independently on a single degree of freedom, as will be explain below with reference to FIGS. 4-8, schematically showing the behavior of the front and rear units (illustrating the corresponding hydraulic cylinders without considering the compression cartridges).

When the cyclist is not mounted on the bicycle the front and rear units are in a maximum extension state or a minimum compression state X0, Y0; in FIGS. 4-8, the front unit is compressed according to an “x” axis and its compression states will be designated with X0, X1, and X2, respectively, X1 being a more compressed state than X0 and X2 being a more compressed state than X1. Similarly, the rear unit is compressed according to a “y” axis and its compression states will be designated with Y0, Y1, and Y2, respectively, Y1 being a more compressed state than Y0 and Y2 being a more compressed state than Y1.

In FIG. 4, the cyclist has mounted the bicycle. His/her weight is distributed on both suspension elements, and due to this the two degrees of freedom are compressed and the volume of air of the compensation chambers thereby reduces increasing the pressure therein. The front and rear units adopt a more compressed state, specifically X1 and Y1 respectively, called “sag” which is the starting point to analyze the behavior of the suspensions (FIGS. 5-8) with respect to the different forces.

FIG. 5 corresponds to an impact on the front wheel. The force in the front axle only affects the front suspension element and one degree of freedom, specifically the front. The compression in the front suspension element (until a degree of compression X2) entails a flow rate Q1 through the unit of holes 1002 and a flow rate Q2 towards the front compensation chamber 1006, reducing the volume thereof, increasing the pressure therein.

FIG. 6 corresponds to an impact on the rear wheel: the force in the rear axle only affects the rear suspension element and one degree of freedom, specifically the rear. The compression in the rear suspension element (until it adopts a compression state Y2) results in a flow rate Q3 through the unit of holes 2002 and a flow rate Q4 towards the rear compensation chamber 2006, reducing the volume thereof, whereby the pressure therein increases.

FIG. 7 relates to what occurs while pedaling. Upon pedaling forces are exerted on the pedals, the handlebar and the saddle. A resultant which is applied in an intermediate position at the axles and which is transmitted to the ground by both axles is produced between the pedals, handlebar and saddle. These forces thus affect the two suspension elements and the two degrees of freedom. In both cases the compression (at the compression states X2 and Y2 respectively, for example) entails flow of a flow rate (Q1 and Q3) through the unit of holes 1002 and 2002 and another flow rate (Q2 and Q4) towards the compensation chambers 1006 and 2006, reducing the volume thereof.

FIG. 8 depicts the situation in the case of braking (negative acceleration). There is a forward inertia force in the centre of gravity of the cyclist while braking that reaches the ground through both axles by means of a compression force in the front axle and extension force in the rear axle. These forces thus affect the two suspension elements and the two degrees of freedom. In the case of the front axle a compression occurs (until the compression state X2, for example) entailing a flow rate Q1 through the unit of holes 1002 and a flow rate Q2 towards the volume of the front compensation chamber 1006 which decreases (increasing the pressure), whereas in the case of the rear axle an extension occurs (until the compression state Y0, for example) entailing a flow rate Q5 through the unit of holes 2002 and a flow rate Q6 from the volume of the rear compensation chamber 2006 increasing its volume (the pressure being reduced). In a speeding up something similar would occur except that the flows of flow rate would be the reverse and the bicycle would roll backwards.

As has been mentioned above, the quality of suspensions depends mainly on the qualities of the hydraulic part and the possible regulations (compression at low speed, compression at high speed, rebound at low speed, rebound at high speed) both over the flow rates Q1, Q3, and Q5 in the unit of holes 1002 and 2002, and over the flow rates Q2, Q4, and Q6 which affect the compensation chamber and which must traverse the units of holes 1005 and 2005.

The movement of the suspensions is desirable in impact absorption so that the energy of the impact or the irregularity of the terrain do not reach the cyclist, or at least reach at a reduced level. Therefore less restrictive regulations of the compression, mainly high speed regulations (impacts) are usually desirable to facilitate the action of the suspensions. This low damping entails that little of the energy transmitted to the suspensions is dissipated during the compression in the form of heat and that most of it accumulates in the absorption element. This absorbed energy is that which causes the subsequent extension to the initial position. If the restriction was also low during extension most of the initial energy would be returned after the compression in the form of a bounce of the wheel with loss of effectiveness and control. To prevent this it is advisable to dampen all the energy absorbed during extension, for which a greater rebound restriction is required. An excessive restriction can also be dangerous due to the fact that the extension would be very slow and could thereby lead to the case where the fork is not entirely extended and does not have its entire capacity upon reaching the following impact.

The movement of the suspensions is not desirable while pedaling and braking. In the first case it absorbs part of the energy from pedaling and the bobbing caused is uncomfortable, and in the second case it causes a change in the geometry, making the angles vertical, which results in a less stable bicycle. Both unwanted movements are low frequency oscillations in comparison with the movement in impact absorption. Therefore, to prevent the action of the suspensions in these conditions, restrictive compression regulations, mainly low speed regulations are usually desirable. This greater damping entails slower movements, whereby with respect to rotating or punctual forces (such as pedaling and braking respectively), the force ceases before the suspension reaches its entire travel, according to the elastic element.

Therefore the conflict in adjusting suspensions is mainly in the compression; the compression being low for impact absorption and high for pedaling or speeding up (including braking) is of interest. The trend that tends to be followed is to heavily restrict (even blocking) compression at low speed to reduce the unwanted movements and then partially restrict compression at high speed so that it provides a sufficient irregularity absorption which does not involve too much movement, for example, upon pedaling or braking. Sometimes this configuration tends to be called “pedaling platform”. In a simplified manner it is understood that in this configuration all the forces below a threshold do not cause movement whereas the forces greater than the threshold cause movement. Although this concept serves to at least partially limit the bobbing of the bicycle upon pedaling, while at the same time allow damping strong impacts, the problem is a certain conflict between the impact absorption and the reduction of bobbing, and often, due to the need of reaching a compromise, the bicycle tended to produce a bobbing movement when it is pedaled rigorously, while at the same time not absorbing small impacts well.

WO-A-2011/138469 describes a suspension system for a bicycle comprising a bicycle frame, a front wheel, and a rear wheel, the suspension system comprising:

a front unit configured to be interposed between the bicycle frame and said front wheel; and

a rear unit configured to be interposed between the bicycle frame and said rear wheel.

The front unit comprises at least one first front hydraulic chamber and a second front hydraulic chamber, and the rear unit comprises at least one first rear hydraulic chamber and a second rear hydraulic chamber. The system comprises a first tube attaching said first front hydraulic chamber with said first rear hydraulic chamber such that there is a hydraulic connection connecting said first front hydraulic chamber and said first rear hydraulic chamber (i.e., such that a hydraulic fluid outlet from one of the chambers can correspond to a hydraulic fluid inlet in the other chamber, and vice-versa), and a second tube attaching said second front hydraulic chamber and said second rear hydraulic chamber such that there is a hydraulic connection connecting said second front hydraulic chamber and said second rear hydraulic chamber.

The system described in WO-A-2011/138469 is configured such that a compression of the front unit produces, through the first tube, when it is in an open state, a hydraulic force on the rear unit for extending the rear unit, and, through the second tube, when it is in an open state, a hydraulic force on the rear unit for compressing the rear unit (and vice-versa).

It can thus be stated that the first tube is associated with a pitching movement since the compression of one of the units contributes to the extension of the other, and vice-versa. It also can be stated that the second tube is associated with one degree of freedom of bobbing since it contributes to a simultaneous compression—or extension of the front and rear units.

It is thus possible to determine the behavior of the suspension and, particularly, the degree of blocking of the bobbing and pitching movement respectively, acting on the communication between the hydraulic chambers, i.e., on the tubes. The configuration thus described allows selectively blocking, and optionally gradually blocking, for example, the pitching and/or the bobbing with valves acting on the communication between the hydraulic cylinders of the front and rear units through the first tube and the second tube. This regulation of the hydraulic connections through the first tube and the second tube can be, for example, manual regulation—such that the cyclist him/herself can control it even while cycling- or more or less automatic regulation, for example, depending on the impacts suffered by the moving bicycle. It is thus possible to prevent the bobbing of the bicycle in the case of rigorous pedaling, while at the same time also allowing a suitable damping of small impacts in the front or rear wheel.

Although the system described in WO-A-2011/138469 can work satisfactorily, it may have some constructive limitations, where it may not be ideal at least in certain cases or where its incorporation in a more or less conventional bicycle may involve certain difficulties and/or require certain changes in the design. Therefore, it has been considered that providing an alternative system which also acts on the degrees of freedom for bobbing and pitching, but with a different configuration of elements which is preferably easily incorporated in conventional bicycles may be desirable.

### DESCRIPTION OF THE INVENTION

A first aspect of the invention relates to a vehicle suspension system (for example, a bicycle, although it also can be applied to other vehicles, for example, a motorcycle) comprising a vehicle chassis (the chassis can be, for example, a frame, for example, a bicycle frame; it can be considered that the frame is not only made up of that which is traditionally considered as the “bicycle frame” itself, but also of the elements attached to this frame, such as the handlebar, the seat, etc., excluding the front and rear wheels), a front wheel, and a rear wheel, the suspension system comprising:

a front hydraulic cylinder configured to be interposed between the chassis and said front wheel; and

a rear hydraulic cylinder configured to be interposed between the chassis and said rear wheel.

Each of these hydraulic cylinders can comprise a cylinder and a piston or plunger which moves in the cylinder which can in turn contain a hydraulic fluid, such as, for example, oil; the plunger can be provided with a hole or with a unit of holes, for example, with a unit of high and low speed holes, as is common in the state of the art; for example, it can be a unit of holes such as that which has been described above in relation to FIG. 2A. Furthermore, the suspension of the invention can, since it is conventional, include the corresponding parts of front and rear dampers, with the corresponding flexible elements, for example, in line with that illustrated in FIGS. 1 and 3.

The suspension system further comprises a first hydraulic connection connecting the front hydraulic cylinder and the rear hydraulic cylinder, such that the hydraulic fluid can pass from the front hydraulic cylinder to the rear hydraulic cylinder through said first hydraulic connection (this first hydraulic connection can comprise, for example, one or several tubes in series and/or in parallel).

According to the invention the system additionally comprises
a first compensation chamber and a second compensation chamber related to one another such that a change of volume ΔV1 of a hydraulic fluid in the first compensation chamber entails a change of volume ΔV2 of a hydraulic fluid in the second compensation chamber, ΔV2=k*ΔV1, k>0.

In other words, the change of volume of hydraulic fluid in one of said compensation chambers is proportional to the change of the volume of hydraulic fluid in the other compensation chamber, and with the same sign, i.e., if the volume of hydraulic fluid in one of said chambers increases, it also increases in the other, and the increase of the volume of hydraulic fluid in both chambers is the same or at least proportional to a coefficient depending on the design of the system. The same applies to the reduction of the volume of the hydraulic fluid in the chambers. It also can be stated that if the volume of the air—or gas, or other mean or elastic element—in one of the compensation chambers reduces or increases, the same occurs in the other in a proportional or substantially proportional manner. The change of the volume of the hydraulic fluid in a compensation chamber must not be understood as that the hydraulic fluid necessarily physically enters (or exits) into (from) a chamber with clearly defined physical limits, but rather an occurrence of the movement of an elastic means (such as, for example, of an airbag), with the subsequent change of the volume of the elastic mean caused by the pressure exerted by the hydraulic fluid directly or through some moveable element.

The suspension system further comprises
a second hydraulic connection connecting the front hydraulic cylinder and the first compensation chamber, such that the hydraulic fluid can pass from the front hydraulic cylinder to the first compensation chamber through said second hydraulic connection (this hydraulic connection can made in any manner, for example, by means of one or several tubes or by means of a direct connection, even with the compensation chamber integrated in the hydraulic cylinder in question, for example, in line with that found in the state of the art described above with reference to FIG. 1);
   and
a third hydraulic connection connecting the rear hydraulic cylinder and the second compensation chamber, such that hydraulic fluid can pass from the rear hydraulic cylinder to the second compensation chamber through said third hydraulic connection (this connection can be made in any manner, for example, by means of one or several tubes or by means of a direct connection, even with the compensation chamber integrated in the hydraulic cylinder in question).

Each hydraulic connection can comprise one or more tubes and can include valves or other elements which allow limiting the flow of the hydraulic fluid through the connection in question. The sensitivity of the system towards different conditions can thus be adjusted and its response can be provided in the form of pitching and/or bobbing.

In other words and in a manner similar to that found in the system described in WO-A-2011/138469, the described configuration allows selectively blocking and optionally gradually blocking, for example, the pitching and/or the bobbing with valves acting on the communication between the hydraulic cylinders and the compensation chambers through the first, second and third hydraulic connections. This regulation of the hydraulic connections can be, for example, manual regulation—such that the user him/herself can control it even while cycling—or more or less automatic regulation, for example, depending on the impacts suffered by the moving vehicle (for example, a bicycle). It is thus possible to prevent the bobbing of the bicycle in the case of rigorous pedaling while at the same time also allowing a suitable damping of small impacts in the front or rear wheel.

On the other hand, its simple configuration which only requires two hydraulic cylinders, a front and another rear cylinder, allows an easy integration of the system in the basic structures of vehicles such as conventional bicycles (since they have a front hydraulic cylinder and another rear hydraulic cylinder). The compensation chambers can be designed in different shapes, including shapes that allow their integration in the front or rear suspension, for example, in the fork of a bicycle itself.

In some embodiments of the invention one of said first compensation chamber and second compensation chamber can be housed inside the other of said first compensation chamber and second compensation chamber. This configuration can be very compact and is particularly suitable for integrating the compensation chambers in a tubular structure, such as the fork of a bicycle or motorcycle. In some embodiments of the invention the cylinder of one of said compensation chambers can be attached to the piston or plunger of the other of said compensation chambers, such that the movement of said plunger entails the movement of said cylinder. This configuration can also be suitable to facilitate the integration of the compensation chambers in a substantially tubular structure.

In some embodiments of the invention said first compensation chamber and second compensation chamber can be concentrically arranged.

In some embodiments of the invention the first compensation chamber can comprise a first plunger and the second compensation chamber can comprise a second plunger, said first plunger and second plunger being, for example, mechanically attached to one another, such that the movement of one of said plungers entails the movement of the other of said plungers. The compensation chambers can, for example, be located in parallel (for example, as illustrated in FIG. 14A) or in series (for example, as illustrated in FIG. 14B).

In some embodiments of the invention the first compensation chamber and the second compensation chamber can be integrated in a front fork of the vehicle. This solution can be very practical since it represents an easily integrated solution which is compatible with the conventional structures of, for example, bicycles.

In such system the second hydraulic connection can comprise at least one tube connecting the second compensation chamber with the rear hydraulic cylinder.

In some embodiments of the invention one of said compensation chambers can be integrated in the front hydraulic cylinder and/or one of said compensation chambers can be integrated in the rear hydraulic cylinder. It can, for example, be integrated such that a tube between the compensation chamber in question and the hydraulic cylinder in question is not necessary, both forming one and the same cylinder.

In some embodiments of the invention both compensation chambers can be integrated in a rear damper of the vehicle. In such system the second hydraulic connection can comprise at least one tube connecting the first compensation chamber with the front hydraulic cylinder.

In some embodiments of the invention the first compensation chamber and the second compensation chamber form a unit arranged outside a front fork of the vehicle and outside a rear suspension of the vehicle. A configuration in which the first compensation chamber is integrated in a fork of the vehicle and in which the second compensation chamber is integrated in a rear damper of the vehicle is also possible. The compensation chambers are associated with one another such that the change of volume of the hydraulic fluid in one of the chambers corresponds to a proportional change of volume of the hydraulic fluid in the other chamber, as has been described above. The chambers can, for example, include plungers attached by a mechanical mechanism.

In some embodiments of the invention the system further comprises a valve located in the first hydraulic connection and in another hydraulic connection, the valve being configured such that said valve controls the opening state of the other hydraulic connection depending on the difference between the pressure in a first part of the first hydraulic connection and a second part of said first hydraulic connection. In other words, the pressure difference between the front hydraulic cylinder and the rear hydraulic cylinder virtually determines the opening state of the other hydraulic connection, which can be the second or the third hydraulic connection; in fact, such valves can be inserted both in the second and in the third hydraulic connection.

In some embodiments of the invention the system further comprises a valve located in the first hydraulic connection and in another hydraulic connection, the valve being configured such that said valve controls the opening state of the first hydraulic connection depending on the difference between the pressure in a first part of the other hydraulic connection and a second part of said other hydraulic connection. In other words, the pressure difference between two parts of the other hydraulic connection, which can be the second or the third hydraulic connection, virtually determines the opening state of the first hydraulic connection. Therefore, the conditions in the degree of freedom of bobbing can regulate the behavior in the degree of freedom of pitching. The behavior of the suspension can be adapted to the users' preferences using several valves of this type.

In some embodiments of the invention said valve can be configured for adopting a closed state when said pressure difference is below a predetermined level and an open state when said pressure difference is above a predetermined level.

In some embodiments of the invention, said valve can be configured for adopting an open state with a degree of opening which increases with said pressure difference.

In some embodiments of the invention said valve can be configured such that it can adopt a closed state in which it prevents the passage of hydraulic fluid through one of the hydraulic connections when hydraulic fluid does not pass through another of the hydraulic connections.

In some embodiments of the invention the valve can comprise a moveable piston configured to enable adopting a blocking position in which it simultaneously blocks the flow of hydraulic fluid through the first hydraulic connection and the flow of hydraulic fluid through the other hydraulic connection, and configured to be able to be moved, by a predetermined pressure difference in the first hydraulic connection, to an unblocking position in which it allows the flow of hydraulic fluid both through the first hydraulic connection and through the other hydraulic connection. Said predetermined pressure difference can be established by means of an elastic element, preferably a spring, which presses the piston towards the blocking position. The valve can comprise a casing provided with at least one first hole, the piston having at least one second hole configured so that a hydraulic fluid can circulate through said second hole as said hydraulic fluid passes through the first hydraulic connection when the piston is in the unblocking position. The piston can further comprise at least a third hole through which a hydraulic fluid can circulate as said hydraulic fluid passes through the other hydraulic connection when the piston is in the unblocking position.

In some embodiments of the invention said other hydraulic connection can be the second hydraulic connection or the third hydraulic connection. Obviously, a valve can simultaneously open and close several hydraulic connections or tubes. For example, one and the same valve can be configured for opening both the second hydraulic connection and the third hydraulic connection depending on a pressure difference between two points associated with the first hydraulic connection.

In some embodiments of the invention said valve can be integrated in a front fork of the vehicle or in a rear damper of the vehicle. Logically, in addition to these valves, there can be more valves for achieving a versatile and optimized high and low speed regulation in several or all the degrees of freedom. In one embodiment of the invention more than one of these valves, for example, all the valves, can be integrated in the front fork. The valves are preferably arranged together to minimize the number of tubes attaching them. Integrating them in the fork or in the rear damper may be an interesting solution.

In some embodiments of the invention the system can comprise a valve located in an intake associated with the front hydraulic cylinder and in an intake associated with the rear hydraulic cylinder, the valve being configured such that said valve controls the opening state of the first hydraulic connection connecting the intake associated with the front hydraulic cylinder and the intake associated with the rear hydraulic cylinder depending on the sum of the pressure in the intake associated with the front hydraulic cylinder and the pressure in the intake associated with the rear hydraulic cylinder.

In some embodiments of the invention said valve can be configured for adopting a closed state when said sum of pressure is below a predetermined level and an open state when said sum of pressure is above a predetermined level.

In some embodiments of the invention said valve can be configured for adopting an open state with a degree of opening which increases with said sum of pressure.

In some embodiments of the invention said valve can be configured such that it can adopt a closed state in which it prevents the passage of hydraulic fluid through the first hydraulic connection connecting the intake associated with the front hydraulic cylinder and the intake associated with the rear hydraulic cylinder when hydraulic fluid does not pass between the intake associated with the front hydraulic cylinder and the first compensation chamber through the first hydraulic connection and/or between the intake associated with the rear hydraulic cylinder and the second compensation chamber through the second hydraulic connection.

Another aspect of the invention relates to a motorcycle or to a bicycle comprising a suspension system according to any of the preceding claims.

An advantage of the invention lies in the hydraulic control of the suspensions based on the degrees of freedom for bobbing and pitching.

The movement of the suspensions of the bicycle or the motorcycle while braking and speeding up can be greatly minimized by restricting the hydraulic connections of the degree of freedom of pitching, maintaining a good absorption capacity as a result of the fact that the hydraulic connections of the degree of freedom of bobbing are less restricted therefore the movement of the suspensions in this direction is made easier. This is of interest in bicycles, but primarily in motorcycles where the speeds and dynamics are greater.

The movement of the suspensions of the bicycle upon pedaling can be greatly minimized by restricting the hydraulic connections of the degree of freedom of bobbing maintaining a good absorption capacity as a result of the fact that the hydraulic connections of the degree of freedom of pitching are less restricted therefore the movement of the suspensions in this direction is made easier. This is of great interest in bicycles but not in motorcycles.

Due to the fact the application of the invention is more varied and complete in bicycles, the invention will be described with reference to embodiments based on bicycles but it should not be forgotten that the advantages described are also applicable to motorcycles, primarily in that relating to the control of the pitching.

### DESCRIPTION OF THE DRAWINGS

To complement the description and for the purpose of aiding to better understand the features of the invention according to several preferred practical embodiments thereof, a unit of drawings is attached as an integral part of said description in which the following has been depicted with an illustrative and non-limiting character:

FIG. 1 schematically illustrates an example of a conventional bicycle fork according to the State of the art.

FIG. 2A schematically illustrates the flow of oil through different holes of a conventional bicycle fork according to the state of the art.

FIG. 2B schematically illustrates the typical curves of the ratio between speed and force determined by the holes of FIG. 2A.

FIG. 3 schematically illustrates a conventional rear damper according to the state of the art.

FIGS. 4-8 schematically illustrate the operation of the conventional full suspension according to the state of the art.

FIGS. 9-13 schematically illustrate a bicycle according to an embodiment of the invention in different load or impact situations.

FIGS. 14A-14C schematically illustrate some alternative embodiments of the compensation chambers according to different embodiments of the invention.

FIGS. 15A-15D schematically illustrate some alternative ways for integrating the compensation chambers in the suspension system according to different embodiments of the invention.

FIG. 16 is a cross-section view of a valve which can form part of a possible embodiment of the invention.

FIG. 17 schematically illustrates a suspension system according to a possible embodiment of the invention with several valves which allow adjusting the behavior of the system.

FIG. 18 schematically illustrates a suspension system according to another possible embodiment of the invention with several valves which allow adjusting the behavior of the system.

FIGS. 19 and 20 schematically illustrate a suspension system according to a possible embodiment of the invention with the compensation chambers arranged coaxially and inside the fork of the vehicle.

### PREFERRED EMBODIMENTS OF THE INVENTION

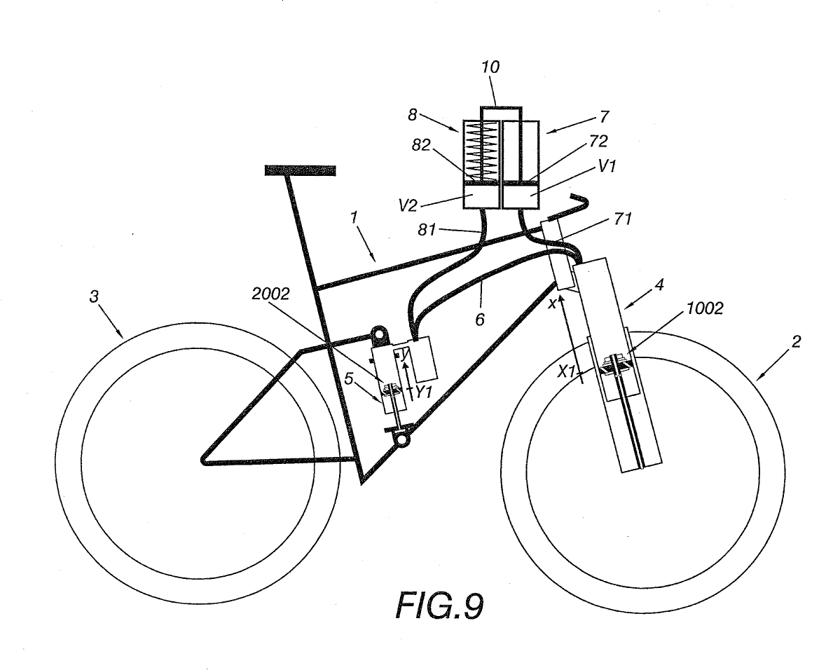

FIG. 9 illustrates a bicycle comprising a bicycle frame 1 (comprising, in addition to the frame itself, a handlebar and seat), a front wheel 2 and a rear wheel 3. The bicycle further comprises a suspension system including a front hydraulic cylinder 4 interposed between the bicycle frame 1 and the front wheel 2, and a rear hydraulic cylinder 5 interposed between the bicycle frame 1 and the rear wheel 3. Each hydraulic cylinder includes a cylinder and a plunger which can move inside the cylinder, such that the hydraulic cylinder tends to be compressed when a compression force is exerted thereon (for example, when a user sits on the bicycle or when there is an impact on the corresponding wheel). There is a first hydraulic connection 6 (for example, through one or several tubes) connecting the front hydraulic cylinder 4 and the rear hydraulic cylinder 5. These hydraulic cylinders can have units of holes 1002 and 2002 such as those conventionally found in such cylinders in the state of the art which have been described above.

Furthermore, as observed in FIG. 9, the suspension system of the bicycle comprises a first compensation chamber 7 and a second compensation chamber 8, related to one another (by means of an attachment or mechanism 10) such that a change of volume ΔV1 of a hydraulic fluid in the first compensation chamber entails a change of volume ΔV2 of a hydraulic fluid in the second compensation chamber, ΔV2=k*ΔV1, k>0. In other words, the change (increase or decrease) of volume of hydraulic fluid in one of said compensation chambers (which corresponds to a change with opposite sign—i.e., decrease or increase—of the volume of air, gas or another/other elastic/compressible element/elements in the compensation chamber) is proportional to the change of volume of hydraulic fluid in the other compensation chamber, and with the same sign, i.e., if the volume of hydraulic fluid in one of said chambers increases it also increases in the other, and the increase of the volume of hydraulic fluid in both chambers is the same, or, at least proportional to a coefficient depending on the design of the system. In FIG. 9 both the compensation chambers have been designed with the same diameter and the plungers 72 and 82 are attached to one another by means of the attachment element or mechanism 10, such that upon lifting one of the plungers the other must inevitably be lifted, therefore if the volume (V1 or V2) of the hydraulic fluid inside one of the chambers (7 or 8) increases, the volume of the hydraulic fluid (V2 or V1) inside the other chamber (8 or 7) inevitably increases by the same measurement. In other words in this case, in formula ΔV2=k*ΔV1 shown above, k=1. Other values of k also fit inside the concept of the invention, provided that k>0.

There is also a second hydraulic connection 71 connecting the front hydraulic cylinder 4 and the first compensation chamber 7, and a third hydraulic connection 81 connecting the rear hydraulic cylinder 5 and the second compensation chamber 8. The connections have been illustrated in the form of tubes but other connections, for example, direct connections are also possible, which could be practical and possible in the cases in which one of the compensation chambers is integrated in a corresponding hydraulic cylinder.

The hydraulic fluid can thus pass:
between the front hydraulic cylinder 4 and the rear hydraulic cylinder 5 (through the first hydraulic connection 6);
between the front hydraulic cylinder 4 and the first compensation chamber 7 (through the second hydraulic connection 71); and
between the rear hydraulic cylinder 5 and the second compensation chamber 8 (through the third hydraulic connection 81).

There can be an elastic element (for example, air, another gas, and/or springs) in both compensation chambers exerting a pressure on the hydraulic fluid, as is conventional in the compensation chambers.

According to this embodiment of the invention the elastic element is common to both compensation chambers.

In some of the drawings illustrating the embodiments of the present invention the compression states of the hydraulic cylinders are indicated according to the two axles “x” (for the front hydraulic cylinder 4) and “y” (for the rear hydraulic cylinder 5). In resting state; in FIGS. 9-13, both hydraulic cylinders 4 and 5 are in a state of maximum extension or minimum compression X0, Y0, the compression states of the front hydraulic cylinder 4 will be designated with X0, X1, and X2 respectively, X1 being a more compressed state than X0 and X2 being a more compressed state than X1. Similarly, the compression states of the rear hydraulic cylinder will be designated with Y0, Y1, and Y2 respectively, Y1 being a more compressed state than Y0 and Y2 being a more compressed state than Y1.

Due to the first hydraulic connection and the particular ratio between the compensation chambers, a ratio is established between the compression and extension states of the hydraulic cylinders affecting the degrees of freedom of pitching and bobbing respectively, in a manner similar to that achieved with the system described in WO-A-2011/138469, but with a different structure which is advantageous at least in some aspects. It can be considered that the present invention is a type of hybrid between the conventional full suspension systems (as have been described above, with a front hydraulic cylinder and a rear hydraulic cylinder) and the system described in WO-A-2011/138469. Advantages similar to those provided by the system of WO-A-2011/138469 in terms of hydraulic control can be achieved with the present invention, but with the possibility of having a structure and an absorption operation similar to those of the conventional full suspension system.

As has been described, in addition to the two suspension elements (with at least one hydraulic cylinder per axle) there is a third connection unit connecting the other two, comprising the two compensation chambers 7 and 8. The two suspension elements can be similar to the conventional suspension elements but with interrelated compensation chambers, as has been described above. Therefore, the structural part of the suspension elements and the absorption part can be the same as the conventional full suspension system, such that the behavior during absorption can be controlled by the classic degrees of freedom. On the other hand, the compensation chambers are attached to one another such that only a joint bobbing movement of both suspension elements is possible. On the other hand, there is an additional connection connecting the two suspension elements such that the pitching movement of the bicycle is produced with the flow of oil from one element to another. Therefore, the hydraulic behavior is also controlled by the degrees of freedom of bobbing and pitching, entailing the advantages of the full suspension system of WO-A-2011/138469. This is an interesting aspect of the invention: The damper can be controlled according to the degrees of freedom for absorption (movements along axles) and/or with respect to the degrees of freedom for bobbing and pitching.

With reference to FIGS. 9-13 the operating principles of the system of the invention will be described briefly below in the context of the illustrated embodiment of the invention. In these examples the hydraulic fluid is oil, although logically other hydraulic fluids inside the scope of the present invention can be contemplated.

In FIG. 9 the user is seated on the bicycle. The weight of the cyclist is distributed between the two suspension elements compressing both suspension elements according to the degrees of freedom of the absorption until the point of reference X1 and Y1 (sag) from which the behavior of the suspension system will be evaluated.

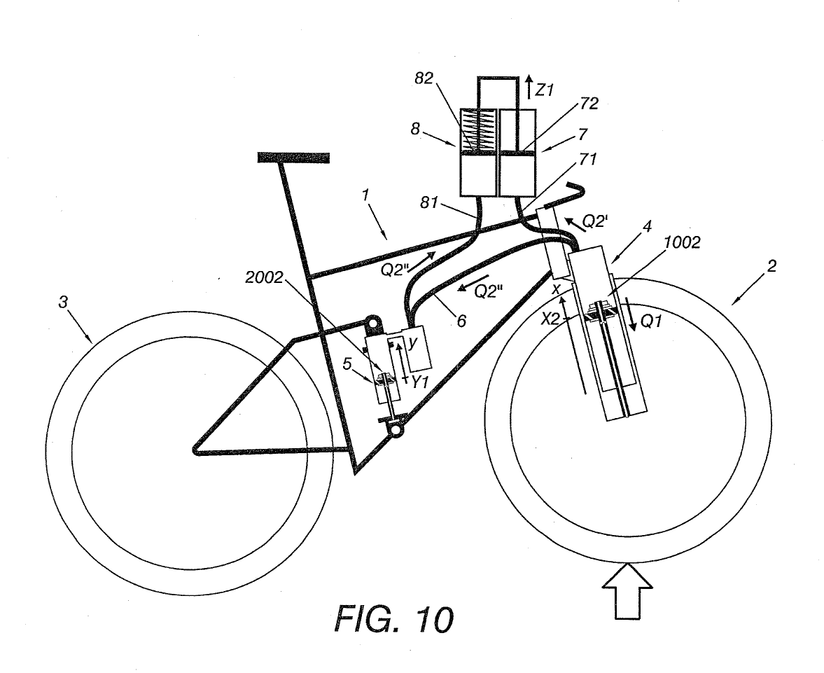

FIG. 10 shows the case of an impact on the front wheel. The force of the front axle compresses the front suspension element according to the degree of freedom of the front absorption to a state X2, for which there has been a flow of flow rate Q1 through the unit of holes 1002 and a flow rate Q2 (or volume of oil or of another hydraulic fluid) which is ejected from the front hydraulic cylinder 4. Part of this flow rate (or volume of oil or another hydraulic fluid) Q2′ goes to the first compensation chamber 7 through the second hydraulic connection 71, and the other part Q2″ goes to the rear hydraulic cylinder 5 through the first hydraulic connection 6. Due to the fact that there are no forces in the rear axle, in an ideal behavior there is no backwards movement (Y1) or volume variation of hydraulic fluid in the rear hydraulic cylinder 5. The flow rate Q2″ (or volume of oil) coming from the front hydraulic cylinder 4 through the first hydraulic connection 6 goes to the second compensation chamber 8 through the third hydraulic connection 81. The distribution of the flow rate (or volume of oil) Q2 in Q2′ and Q2″ is determined by the diameters of the plungers 72 and 82, therefore both compensation chambers undergo one and the same compression Z1. This compression entails pressure increase in the air chamber and also in the rest of the hydraulic circuit. This increase of compression should cause a slight extension of the rear hydraulic cylinder 5 in view of the difference of areas due to the rod of the plunger, but due to the fact that the pressure increase will preferably not be excessive and that the difference of areas will also not be excessive, the movement of the hydraulic cylinder 5 is considered insignificant and will not be taken into account in this conceptual explanation of the idea. Similarly, the dynamic behavior in which different areas of pressure are generated in the hydraulic circuit, which behavior generates the flow of oil from the areas of higher pressure to the areas of lower pressure is also not taken into account in the conceptual explanation.

Therefore, the hydraulic behavior is similar to that of the system described in WO-A-2011/138469: part of the oil flows from the front unit through the degree of freedom of bobbing and another part through the degree of freedom of pitching compressing the unit, whereas in the rear unit there is a flow of oil through the degree of freedom of bobbing and through the degree of freedom of pitching which compensate one another, without there being movement in the rear unit.

(The hydraulic operation tends to be expressed primarily by pressures and flow rates. From a strict view point, FIGS. 9-13 and 19-20 are static positions—non dynamic positions—, where the differences illustrated are the differences of volume rather than flow rates. Therefore, the person skilled in the art understands that the references to flow rates made in relation to these drawings in fact involve changes of volume between the different time instants corresponding to the drawings.)

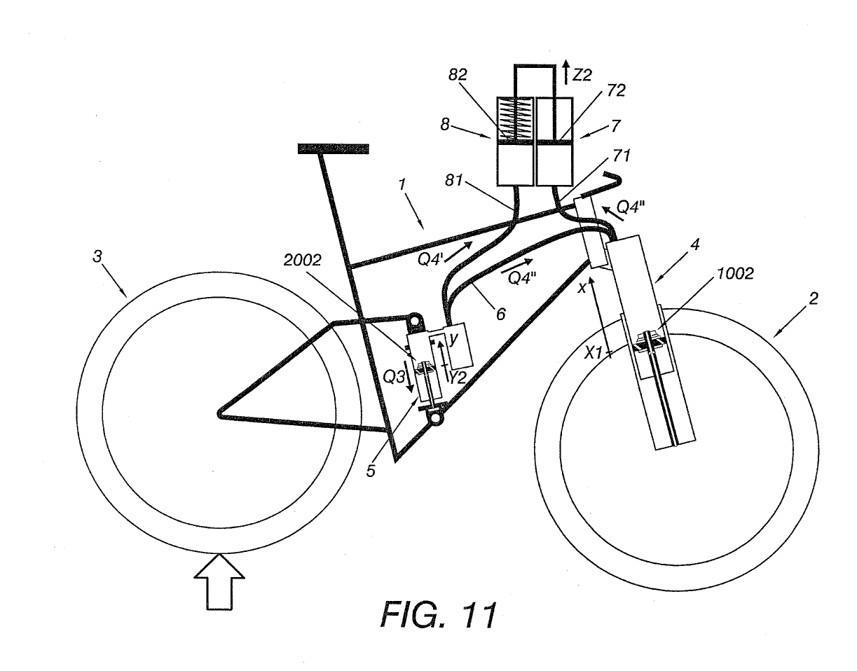

FIG. 11 shows the case of a rear impact. The rear axle is compressed to a state Y2, for which there has been a flow of flow rate Q3 through the unit of holes 2002 and a flow rate (or volume) Q4 which is ejected from the rear hydraulic cylinder 5. Part of this flow rate (or volume) Q4′ goes to the second compensation chamber 8 through the third hydraulic connection 81, and the other part Q4″ goes to the front hydraulic cylinder 4 through the first hydraulic connection 6. Due to the fact that there are no forces in the front axle, in an ideal behavior there is no front movement (X1) or volume variation of oil in the front hydraulic cylinder 4; the flow rate (or volume) Q4″ coming through the first hydraulic connection 6 goes to the first compensation chamber 7 through the second hydraulic connection 71. The distribution of the flow rate (or volume) Q4 is determined by the diameters of the plungers 72 and 82 so that one and the same compression Z2 occurs in both compensation chambers.

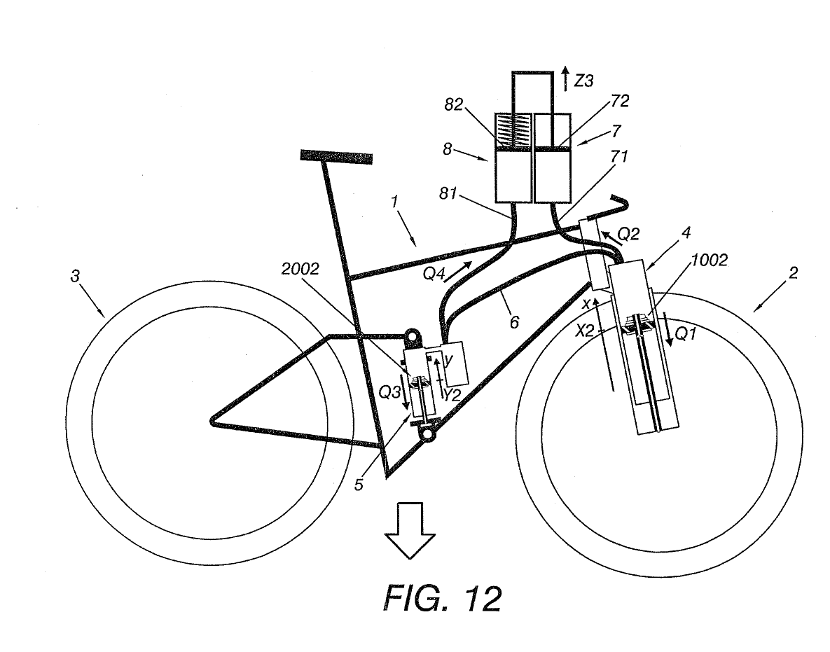

FIG. 12 shows the influence of pedaling: the forces act on both axles, therefore both hydraulic cylinders are compressed (and they adopt, for example, the compression states X2 and Y2 respectively), since a flow rate (or volume) Q1 has passed through the unit of holes 1002 and a flow rate (or volume) Q3 has passed through the unit of holes 2002, and flow rates (or volumes) Q2 and Q4 have been ejected from the front hydraulic cylinder 4 and rear hydraulic cylinders 5, respectively. In an ideal pedaling condition the ratio of flow rates (or volumes) Q2/Q4 corresponds to the ratio of areas of the plungers 72 and 82, such that there is no flow of oil through the first hydraulic connection 6. Therefore, only the degree of freedom of bobbing acts in pedaling. In a non-ideal pedaling condition the ratio of flow rates (or volumes) Q2/Q4 does not correspond precisely to the ratio of areas of the plungers 72 and 82, therefore there must be a small flow through the tube 6 whereby the pedaling also acts lightly on the degree of freedom of pitching, but most of the movement continues being through the degree of freedom of bobbing.

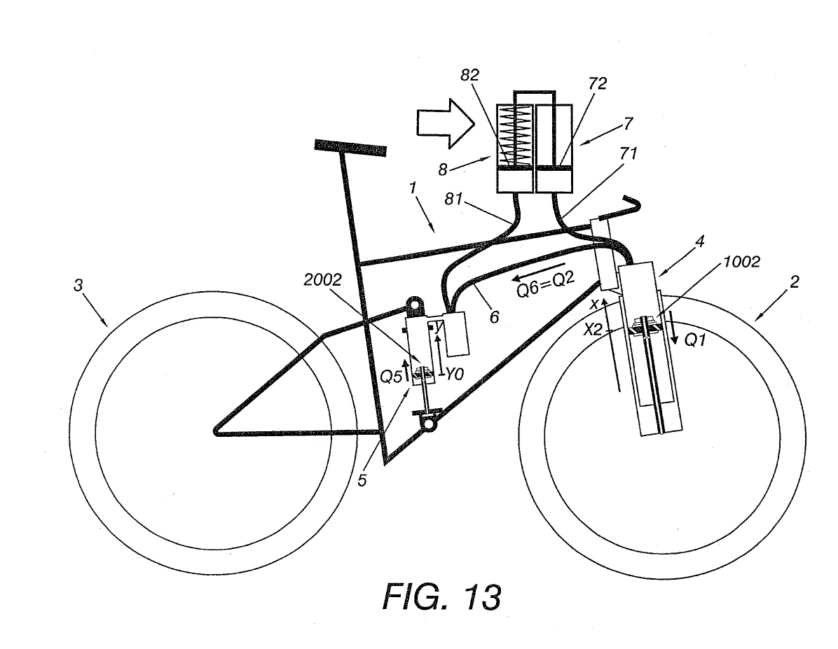

FIG. 13 shows the case of braking. A variation occurs in the weight distribution in braking. The weight increase in the front axle compresses the front unit to a compression state X2 and extends the rear unit to a compression state Y0. To that end, a flow rate (or volume) Q1 passed through the unit of holes 1002 and a flow rate (or volume) Q5 passed through the unit of holes 2002, a flow rate (or volume) Q2 has been ejected from the front hydraulic cylinder 4 and a flow rate (or volume) Q6 has been drawn from the rear hydraulic cylinder 5. In an ideal configuration in which the dimensions of the cylinders 4 and 5 correspond to the distribution of the reactions while braking, the flow rate (or volume) Q2 will be the same as the flow rate (or volume) Q6, such that the flow of oil occurs exclusively through the degree of freedom of pitching (i.e., through the first hydraulic connection 6), like in the full suspension system of WO-A-2011/138469. In a non-ideal configuration the braking would cause a slight movement of the degree of freedom of bobbing, but most of the movement will always be caused by the pitching.

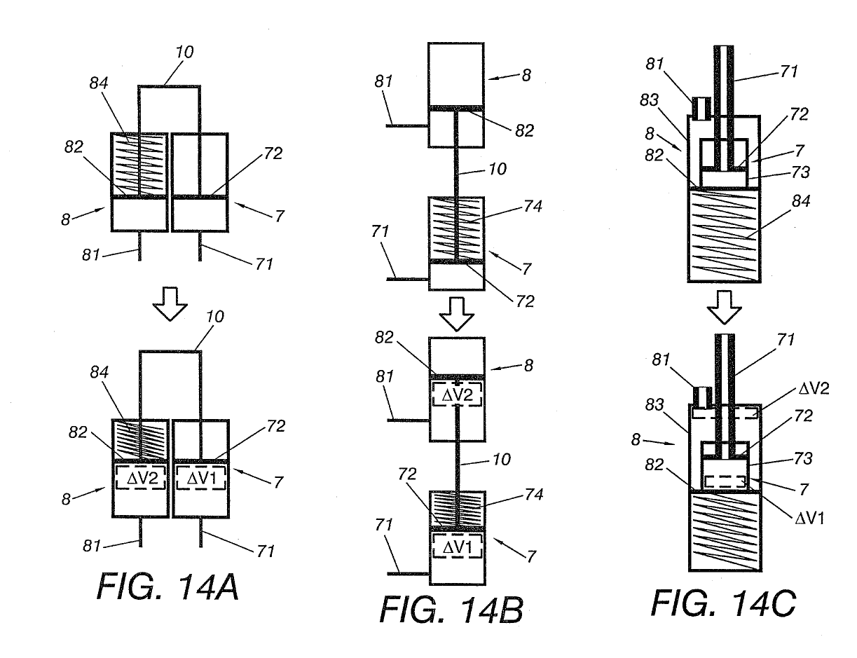

The compensation chambers of FIGS. 9-13 can be configured in several other manners achieving the same behavior provided that in their joint movement they maintain the same ratio of volume variations ΔV1/ΔV2. FIGS. 14A-14C show for example three possible configurations for the compensation chambers, specifically, in parallel (FIG. 14A), in series (FIG. 14B) and concentric (FIG. 14C) (in FIGS. 14A-14C also show the changes ΔV1 and ΔV2 in the volume of the hydraulic fluid in the chambers between a less compressed state and another more compressed state).

How the mechanical attachment (through a direct mechanical attachment 10) between the plungers 72 and 82 of the compensation chambers means that the movement of one of the plungers entails the movement of the other plunger can be observed in FIGS. 14A and 14B, therefore the change of volume of the hydraulic fluid in both chambers is the same or proportional.

How the first compensation chamber 7 is housed inside the second compensation chamber, and how the cylinder 73 of the first compensation chamber 7 is attached to the plunger 82 of the second compensation chamber 8 is observed in FIG. 14C, such that the movement of said plunger 82 entails the movement of said cylinder 73. In other words, when the plunger 82 of the second compensation chamber moves inside the cylinder 83 of the second compensation chamber, it entrains the cylinder 73 of the first compensation chamber therewith, whereby this cylinder moves with respect to the plunger 72 of the first compensation chamber. Therefore, as can be understood from FIG. 14C, a change of volume of hydraulic fluid ΔV1 occurs in the first compensation chamber 7 which is proportional to the change of volume of hydraulic fluid ΔV2 in the second compensation chamber 8.

How at least one of the chambers comprises an elastic element 74 (FIG. 14B) or 84 (FIGS. 14A and 14C) which can be a spring or a gas is also observed. Due to the interrelation of the two compensation chambers, it may be sufficient that one of them contain such elastic element, although it is also possible that both compensation chambers contain elastic elements.

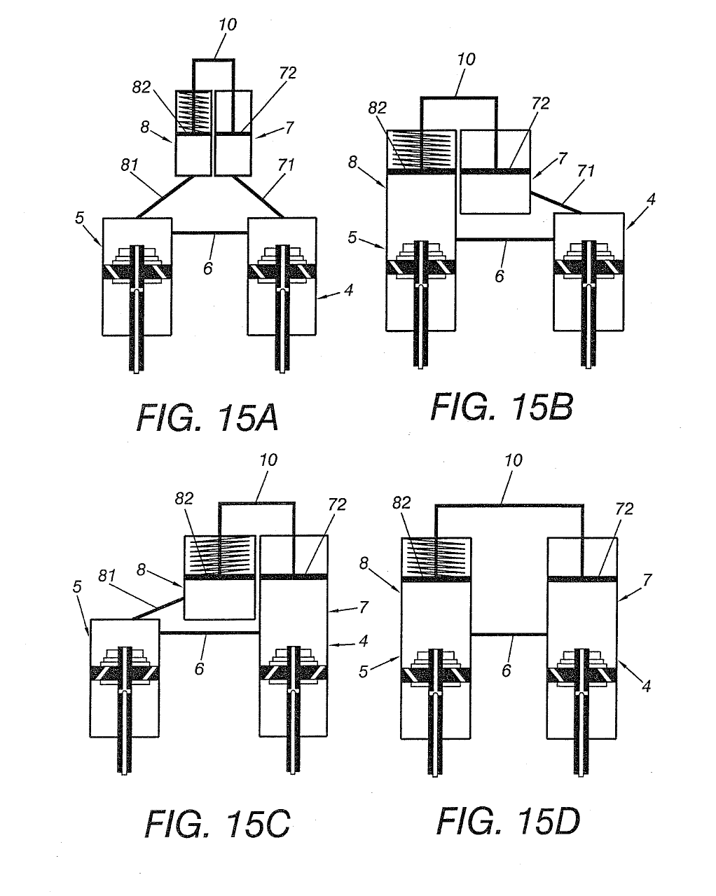

On the other hand, the compensation chambers can be positioned in different places without varying the basic operation of the system, as shown in FIGS. 15A-15D, illustrating different ways of integrating the compensation chambers in the suspension system.

In FIG. 15A the unit of compensation chambers is independent of the front hydraulic cylinder 4 and rear hydraulic cylinder 5 (although it may or may not be integrated in the rear damper or in the fork).

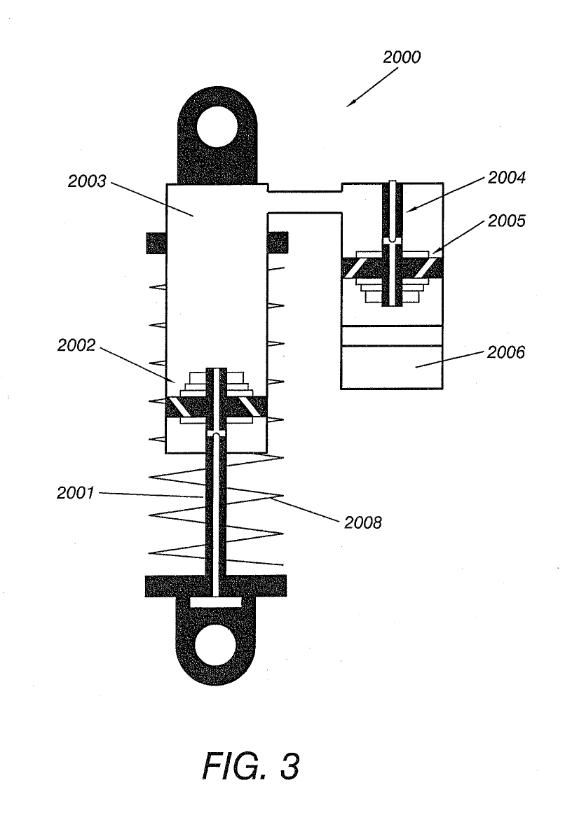

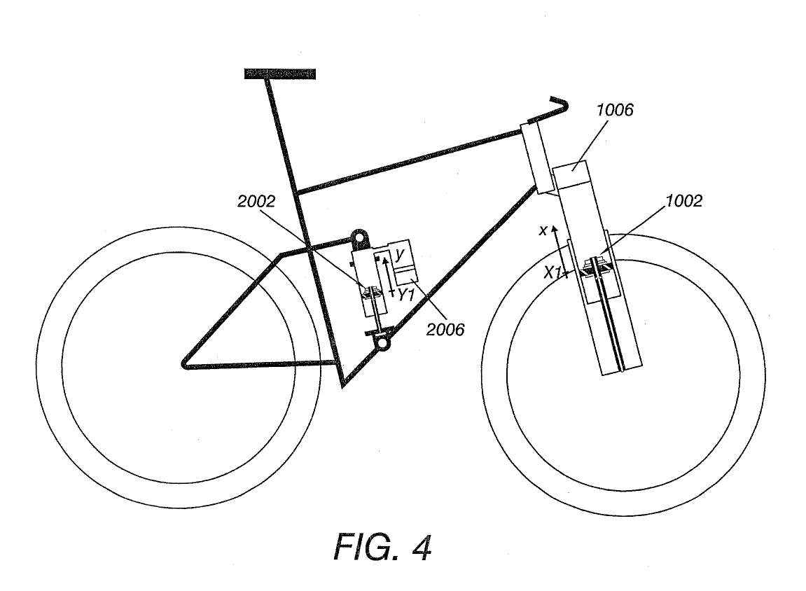

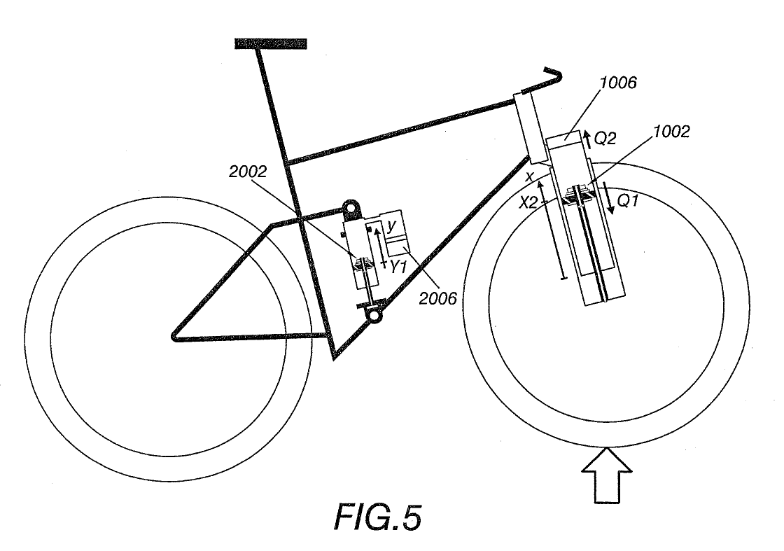

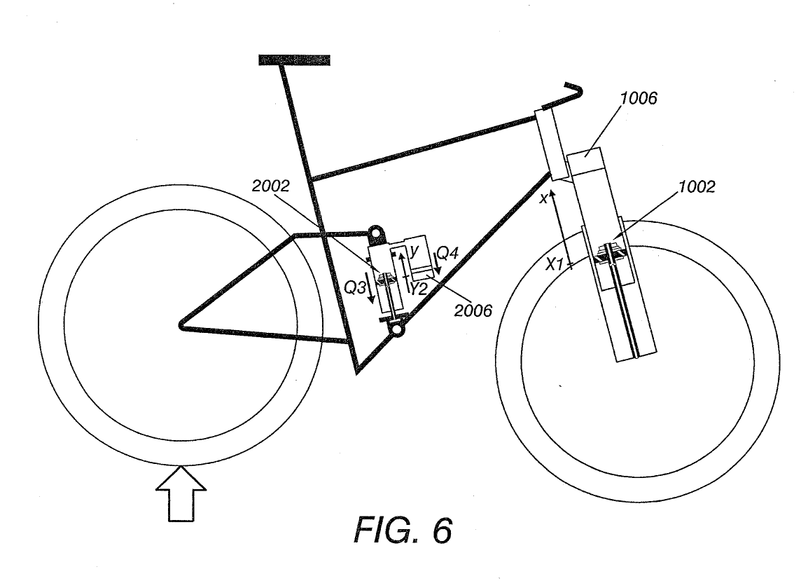

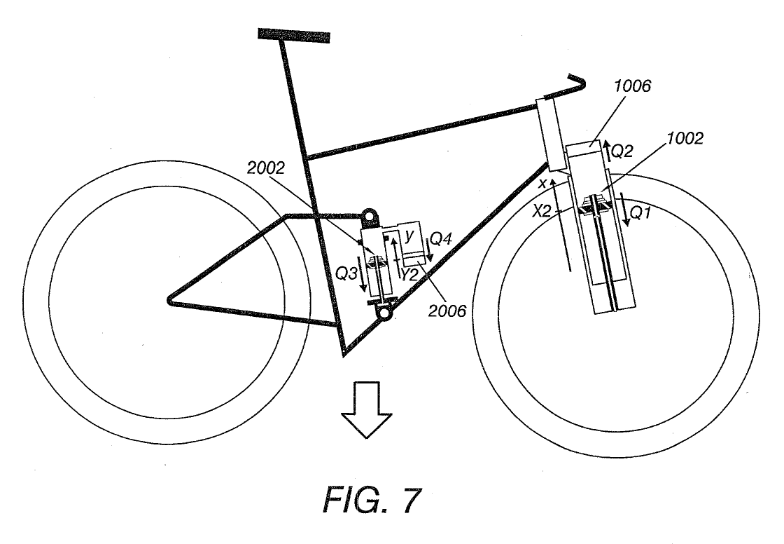

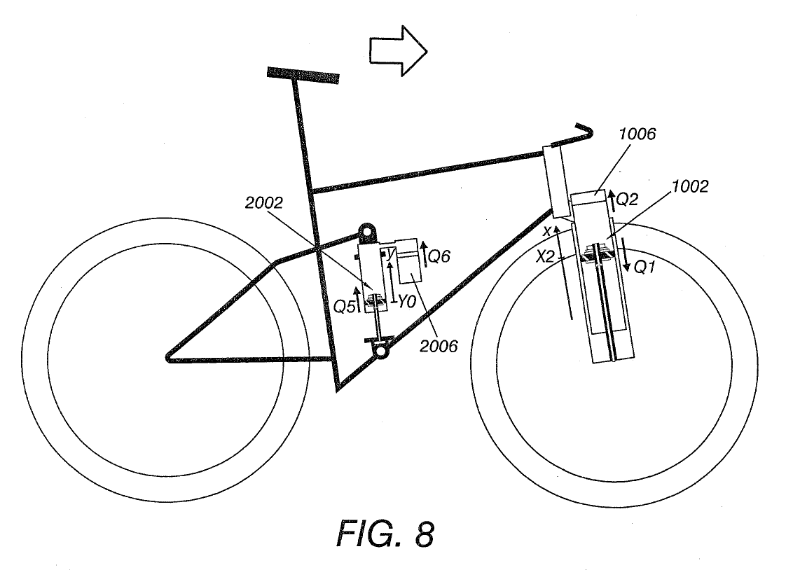

In FIG. 15B the unit of compensation chambers forms part of the rear damper making up the rear hydraulic cylinder 5 and the cylinder 83 (following the nomenclature of FIG. 14) of the second compensation chamber 8 making up one and the same hydraulic cylinder containing both the hydraulic piston and the compensation chamber (similarly to a commercial damper, see FIG. 3).

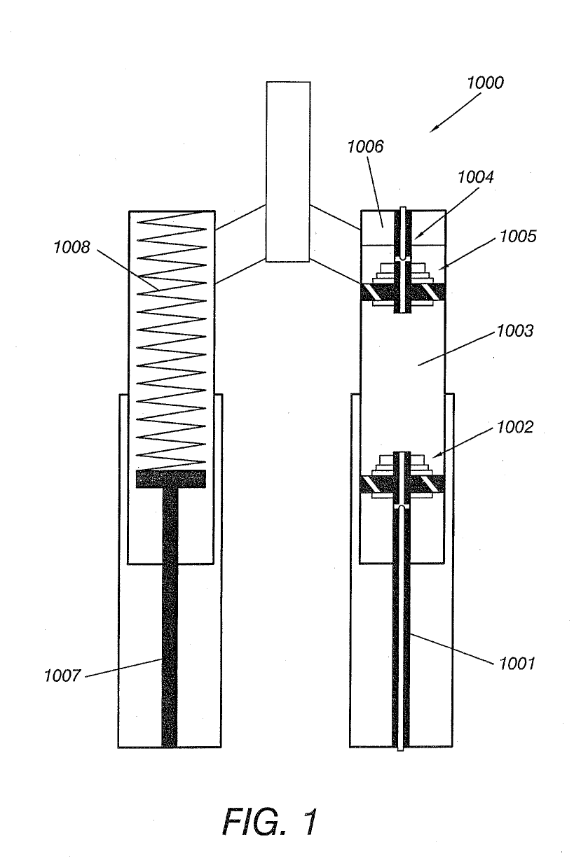

In FIG. 15C the unit of compensation chambers forms part of the fork making up the hydraulic chamber of the front hydraulic cylinder 4 and the hydraulic cylinder of the first compensation chamber 7 making up one and the same hydraulic cylinder containing both the hydraulic piston and the compensation chamber (similarly to a commercial fork, see FIG. 1).

In FIG. 15D the first compensation chamber 7 forms part of the front hydraulic cylinder 4, while the second compensation chamber 8 forms part of the rear hydraulic cylinder 5, and the unit further has an element or a mechanism 10 transmitting the movement between the first compensation chamber 7 and second compensation chamber 8 establishing the ratio of change of volume ΔV1/ΔV2.

Therefore any system combining FIGS. 14 and 15, as well as any other variant deduced by a person skilled in the art, entails the possibility of controlling the hydraulic behavior of the suspensions based on the degrees of freedom of bobbing and pitching, and thus enable achieving the advantages in controlling unwanted movements mentioned in WO-A-2011/138469.

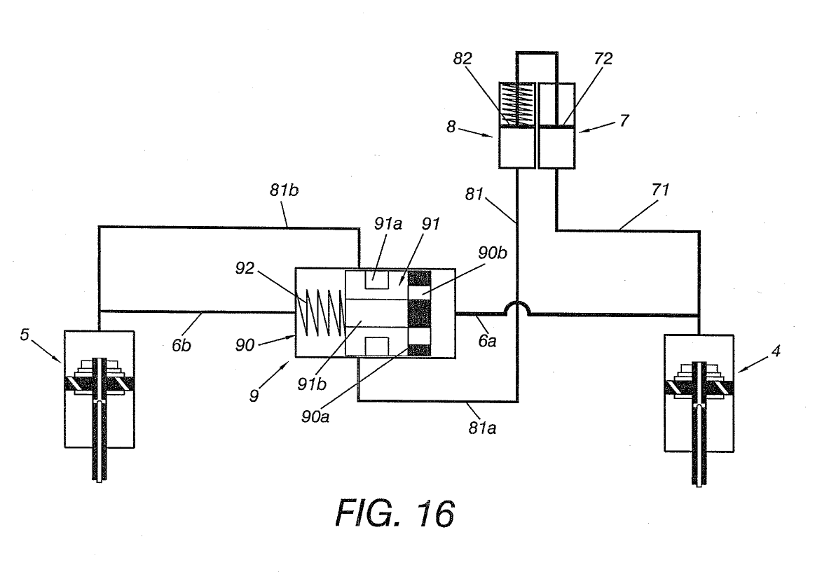

Therefore, similar to that described in WO-A-2011/138469, one or more valves can be incorporated to influence the behavior of the system according to the different degrees of freedom, for example, to block the degree of freedom of bobbing depending on the degree of freedom of pitching. A valve 9 the opening state of which depends on, for example, the pressure difference between the front hydraulic cylinder 4 and the rear hydraulic cylinder 5 can, for example, be incorporated in the second hydraulic connection 71 and/or in the third hydraulic connection 81. An example of such valve is observed in FIG. 16. The valve 9 is made up of a casing 90, a plunger or an inner piston 91 and a spring 92. In an initial blocking state (depicted in FIG. 16), the inner piston 91 is in a blocking position and contacts the wall 90a of the casing 90 due to the force exerted by the spring 92 which, in the position of FIG. 16, has a certain preload. In this initial state, both the flow through the tube of the first hydraulic connection 6, between the intakes 6a and 6b, and the flow through the tube of, for example, the third hydraulic connection 81, between the intakes 81a and 81b, are blocked by the piston 91.

All the pressure difference in the first hydraulic connection 6 (pressure in the intake 6a with respect to the pressure in the intake 6b) falls on the piston 91 through the holes 90b of the casing 90. When the force is greater than the preload of the spring 92 due to said pressure difference, the piston 91 moves compressing the spring 92. Thereby opening up a passage for the fluid of the first hydraulic connection 6, circulating from the intake 6a going through the hole 90b of the casing 90 and through the central hole 91b of the piston 91 to the intake 6b. Similarly, the movement of the piston towards its unblocking position enables the flow between the intakes 81a and 81b through the outer annular hole 91a of the piston 91 provided that there is a pressure difference between both intakes.

Starting from the sag or equilibrium state of FIG. 9, with a front compression X1, back compression Y1, and a constant pressure throughout the hydraulic circuit, the repercussion of the valve 9 in the behavior of the bicycle with respect to a front impact and the pedaling forces is described below according to the arrangement depicted in FIG. 16.

The pressure in the front hydraulic cylinder 4 increases with respect to a front impact and the pressure in the first compensation chamber 7 also increases due to the second hydraulic connection 71. The valve 9 being closed and therefore there not being any volume variations in the compensation chambers, the sum of the forces on the plungers 72 and 82 must be maintained, which entails the pressure in the second compensation chamber 8 to decrease in proportion to the increase of the pressure in the first compensation chamber 7. On the other hand in the absence of forces in the rear wheel, a pressure variation does not occur in the rear hydraulic cylinder 5. The pressure of the front hydraulic cylinder 4 is transmitted to the valve 9 through the first hydraulic connection 6 (through the intake 6a), the pressure of the second compensation chamber 8 is transmitted to the valve 9 through the third hydraulic connection 81 (through the intake 81a), and the pressure of the rear hydraulic cylinder 5 is transmitted to the valve 9 through the intakes 6b (corresponding to the first hydraulic connection) and 81b (corresponding to the third hydraulic connection). The pressure difference between the intakes 6a and 6b opens the valve 9 whereby the intake 6a is connected to the intake 6b and the intake 81a is connected to the intake 81b. Due to the pressure difference between the front hydraulic cylinder 4 and rear hydraulic cylinder 5, a flow rate Q2″ occurs according to FIG. 10, and due to the pressure difference between the rear hydraulic cylinder 5 and the second compensation chamber 8 that flow rate (or volume) Q2″ moves to the second compensation chamber 8 varying its volume, and at the same time varying the volume of the compensation chamber 7 entailing a flow rate Q2′ (or volume of oil) from the cylinder 4, all of this according to FIG. 10.

On the other hand, reaction forces are generated in both axles on pedaling, which increases the pressure both in the front hydraulic cylinder 4 and in the rear hydraulic cylinder 5. The pressure increase therewith entails pressure increase in the first compensation chamber 7 and pressure reduction in the second compensation chamber 8. All these pressures are transmitted to the valve 9 through the connections or intakes 6a, 6b, 81a and 81b. Due to the pressure increase both in the front hydraulic cylinder 4 and in the rear hydraulic cylinder 5, there is no pressure difference between the intakes 6a and 6b, or the pressure difference is not sufficient to overcome the preload of the spring 92, therefore the valve remains closed. Therefore, despite the pressure difference between the intakes 81a and 81b, the presence of the valve 9 blocks the flow rates which are shown in FIG. 12.

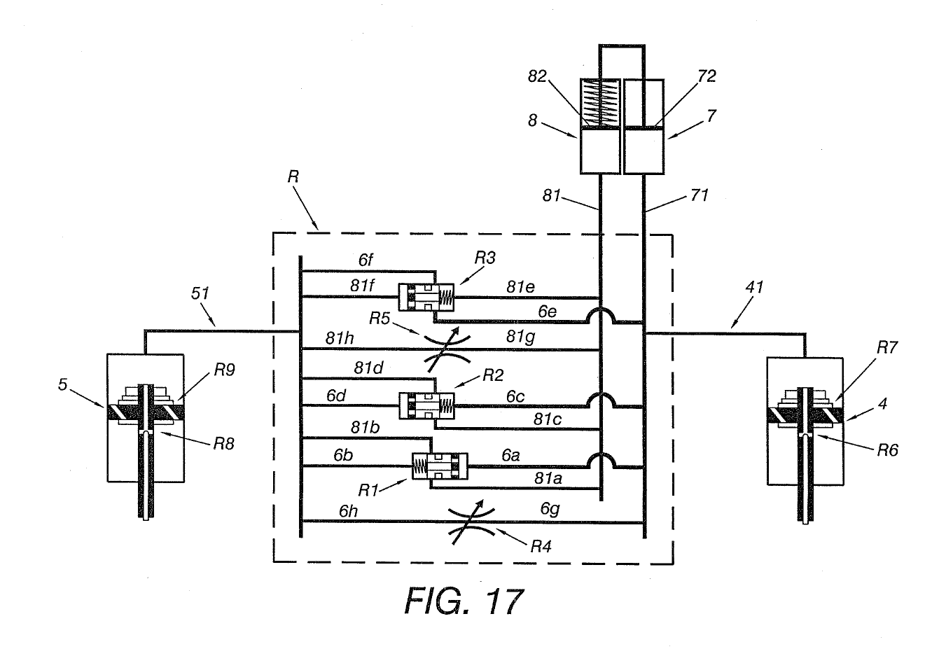

Therefore, with this valve 9 which is called R1 in FIG. 17, the operation of the suspensions during pedaling is prevented whereas the operation with respect to a front impact is maintained. The same can be applied to the rear wheel, mutatis mutandis, for example, by applying a valve 9 arranged in the first hydraulic connection in a reverse manner in the regulation form R2 according to FIG. 17, based on the connections or intakes 6c, 6d, 81c and 81d.

On the other hand, the valve 9 can also be used to control the pitching while braking or speeding up according to the regulation R3 of FIG. 17. While braking, the force on the front axle increases whereas the force on the rear axle reduces by the same measurement, which entails the pressure in the front hydraulic cylinder 4 to increase and the pressure in the rear hydraulic cylinder 5 to decrease. The increase of the pressure in the front hydraulic cylinder 4 entails the increase of the pressure in the first compensation chamber 7 and its decrease in the second compensation chamber 8. The pressures are transmitted to the valve R3 through the connections 6e, 6f, 81e and 81f in FIG. 17. Due to the decrease of pressure in the rear hydraulic cylinder 5 and in the second compensation chamber 8, there is no pressure difference between the connections 81e and 81f, or the pressure difference is not sufficient to overcome the preload of the spring 92, therefore the valve remains closed. Therefore, despite the pressure difference between the connections 6e and 6f, the presence of the valve R3 blocks the flow rates which are shown in FIG. 13.

Similarly, with respect to speeding up, the force on the rear axle increases while it reduces by the same measure on the front axle. Therefore, the pressure in the front hydraulic cylinder 4 and in the first compensation chamber 7 drop and increase in the rear hydraulic cylinder 5 and in the second compensation chamber 8, therefore there is also no pressure difference between the intakes 81e and 81f, whereby the valve remains closed preventing the movement of the suspensions despite the pressure difference between the intakes 6e and 6f (this feature can be interesting for bicycles but, perhaps, particularly interesting for motorcycles).

However, in a front impact, the pressures of the front hydraulic cylinder 4 and the first compensation chamber 7 increase, the pressure in the second compensation chamber 8 drops, and the pressure in the rear hydraulic cylinder 5 remains unchanged. A pressure difference is thus generated between the connections 81e and 81f opening the valve R3 which causes a movement of the suspensions according to FIG. 10. The same can be applied to a rear impact, mutatis mutandis, in the which the pressure in the rear hydraulic cylinder 5 increases and the pressures of the front hydraulic cylinder 4 and the compensation chambers 7 and 8 remain unchanged, a pressure difference will therefore occur between the connections 81e and 81f opening the valve R3. The valve R3 thus prevents the operation of the suspensions during braking and speeding up whereas the operation with respect to the impacts is maintained.

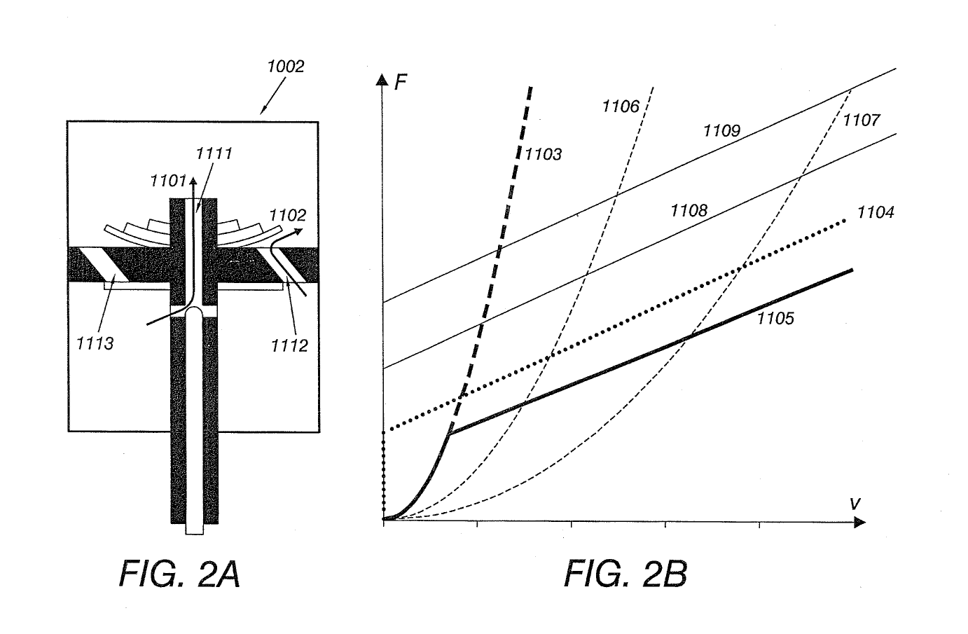

In FIG. 17 the high speed regulations in pitching R1-R2 (establishing a blocking of the degrees of freedom of pitching and bobbing the unblocking of which depends on the forces in the degree of freedom of pitching) and high speed regulations in bobbing R3 (establishing a blocking of the degrees of freedom of pitching and bobbing the unblocking of which depends on the forces in the degree of freedom of bobbing), are complemented with the low speed regulations in pitching R4 and low speed regulations in bobbing R5. The low speed regulations R4 and R5 are holes the section of which can be adjusted in a manner similar to the main hole 1111 of FIG. 2A. In FIG. 17, the connections or intakes 6a, 6c, 6e, 6g, and 71 are attached to the front hydraulic cylinder 4 by means of the connection or intake 41, whereas the connections or intakes 6b, 6d, 6f, 6h, 81b, 81d, 81f and 81h are attached to the rear hydraulic cylinder by means of the connection or intake 51. A unit of valves R which has the regulations R1-R5 and which is connected to the connections 41, 51, 71 and 81 is thus defined, for controlling the suspensions according to the degrees of freedom of pitching and bobbing.

Furthermore, the conventional hydraulic regulations (i.e., those which are already used in the state of the art) are also applicable in the piston of each suspension element; in FIG. 17 these regulations have been indicated as R6-R7 and R8-R9 respectively, and they can be similar to the valves or holes 1111 and 1112 of FIG. 2A. With the configuration of FIG. 17 an interesting combination of regulations (between systems of degrees of freedom) is thus achieved in which the compression of the suspension elements is controlled based on the degrees of freedom of pitching and bobbing to effectively limit the unwanted movements, and the rebound of the suspension elements is controlled based on the classic and conventional degrees of freedom, for example, for a fine adjustment (along axles) of the desired movements.

In addition to the configuration of FIG. 17, other combinations based on similar valves for these and other regulations over the new degrees of freedom for bobbing and pitching or the classic degrees of freedom, as well as different configurations (such as, for example, those of FIGS. 14A-14C) and arrangements (such as, for example, those of FIGS. 15A-15D) of the compensation valves are possible. The bobbing regulations can be performed on the second hydraulic connection 81, on the first hydraulic connection 71, or on both.

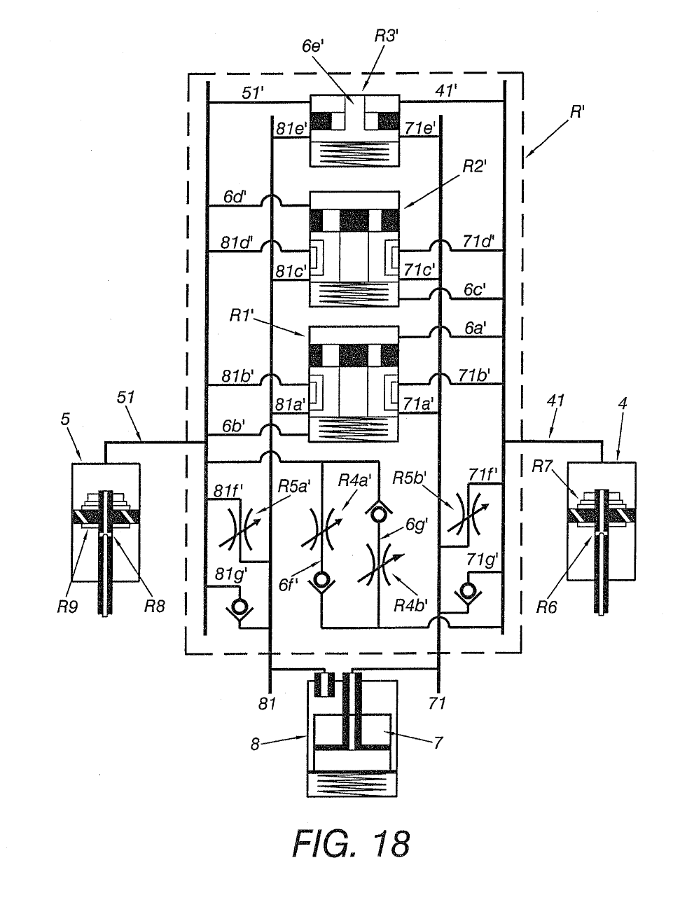

FIG. 18, for example, depicts an alternative configuration of great interest combining a unit of valves R′ with a unit of compensation chambers 7 and 8 such as that of FIG. 14C, in which the valves act on the two hydraulic connections 71 and 81 in the bobbing:

R1′: Regulation of high speed diving: when the pressure in the connection 6a′ exceeds the pressure in the connection 6b′ at least that corresponding to the preload of the valve R1′, the valve connecting the connection 6a′ with 6b′, 71a′ with 71b′ and 81a′ with 81b′ opens.

R2′: Regulation of high speed squatting: when the pressure in the connection 6d′ exceeds the pressure in the connection 6c′ at least that corresponding to the preload of the valve R2′, the valve connecting the connection 6c′ with 6d′, 71c′ with 71d′ and 81c′ with 81d′ opens.

R3′: Regulation of high speed downward bobbing: The pressure of the front hydraulic cylinder 4 and rear hydraulic cylinder 5 fall directly on the piston of the valve R3′ through the connections 41′ and 51′ each discharging at either side of the piston keeping the connections 41′ and 51′ separated from one another when the valve is closed. In other words, the oil of front hydraulic cylinder 4 enters at one side of the piston and the oil of the rear hydraulic cylinder 5 enters at the other side, and both oils press on the spring of the valve. The preload of the valve R3′ is preferably adjusted at a value compensating the pressures in initial sag state, thus the valve remains closed while the sum of the reactions of both axles is the same, which includes braking and speeding up in which the reactions of each axle vary but the sum thereof remains constant. When the pressure in one of the connections 41′ or 51′ increases more than the pressure drops in the other, the valve opens and communicates the connection 41′ with the connection 71e′, the connection 51′ with 81e′, and the connection 41′ with 51′ by means of the inner connection 6e′ which stops separating both sides due to the movement of the piston.

R4a′: Regulation of low speed diving: the flow rate of passage through the tube 6f′ from the front hydraulic cylinder 4 to the rear hydraulic cylinder 5 is adjusted. The one way valve of the tube 6f′ blocks any flow rate from the rear hydraulic cylinder 5 to the front hydraulic cylinder 4.

R4b′: Regulation of low speed squatting: the flow rate of passage through the tube 6g′ from the rear hydraulic cylinder 5 to the front hydraulic cylinder 4 is adjusted. The one way valve of the tube 6g′ blocks any flow rate from the front hydraulic cylinder 4 to the rear hydraulic cylinder 5.

R5a′ and R5b′: Regulations of low speed downward bobbing: they regulate the flow rate of passage from the front hydraulic cylinder 4 to the first compensation chamber 7 through the connection 71f′ and from the rear hydraulic cylinder 5 to the second compensation chamber 8 through the connection 81f. Due to the attachment between the compensation chambers 7 and 8, both regulations affect both flow rates since these flow rates are always related according to ratio ΔV1/ΔV2.

Besides these regulations, the connections 71g′ and 81g′ drive the flow rate of the upward bobbing from the first compensation chamber 7 to the front hydraulic cylinder 4 and from the second compensation chamber 8 to the rear hydraulic cylinder 5 through the one way valves. The upward bobbing of the suspensions is controlled by means of the classic rebound high and low speed regulations of each axle R6-R9.

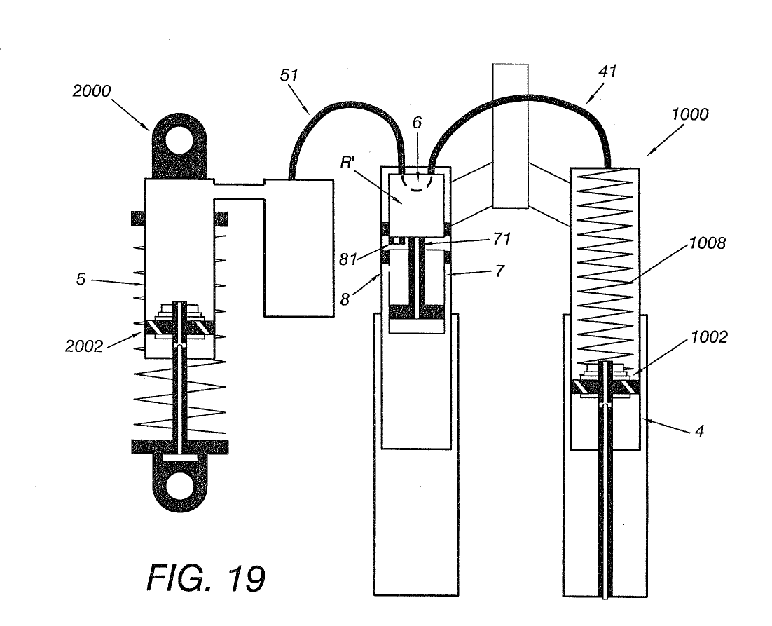

In a preferred configuration for a better integration of the proposed system, the unit of valves (R, R′, . . . ) and the unit of compensation chambers (7, 8) are integrated inside the fork 1000, for example, inside the left bar of the fork after moving the spring 1008 to the right bar as shown in FIG. 19.

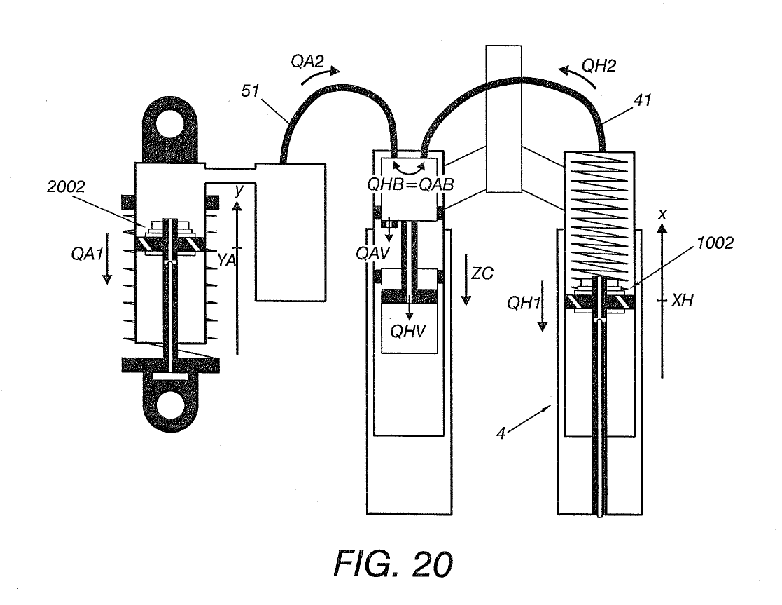

FIG. 20 shows the flows of flow rate through the proposed suspension system when the fork is compressed by an amount XH and the damper by an amount YA, considering that all the valves of the unit of valves R′ are at least partially open. The compression of the fork involves a flow rate QH1 through the unit of holes 1002 and a flow rate QH2 through the connection 41. The compression of the damper involves a flow rate QA1 through the unit of holes 2002 and a flow rate QA2 through the connection 51. Inside the unit of valves the flow rate QH2 divided into a flow rate of pitching QHB and a flow rate of bobbing QHV (QH2=QHB+QHV), whereas the flow rate QA2 is divided into a flow rate of pitching QAB and a flow rate of bobbing QAV (QA2=QAB+QAV), the following ratios being achieved:
The flow rates of pitching have the same value and opposite sign (QHB=−QAB).
The flow rates of bobbing maintain the ratio of volumes corresponding to the unit of compensation chambers corresponding to the extension ZC (QHV/QAV=ΔV1/ΔV2).

In this text, the word “comprises” and variants thereof (such as “comprising”, etc.) must not be interpreted in an excluding manner, i.e., they do not exclude the possibility that what is described may include other elements, steps, etc.

On the other hand, the invention is not limited to the specific embodiments which have been described, but it also encompasses, for example, the variants which can be carried out by a person skilled in the art (for example, in terms of the choice of materials, dimensions, components, configuration, etc.), within what is inferred from the claims.

1. Suspension system for a vehicle comprising a vehicle chassis (1), a front wheel (2), and a rear wheel (3), the suspension system comprising:
a front hydraulic cylinder (4) configured to be interposed between the chassis (1) and said front wheel (2);
a rear hydraulic cylinder (5) configured to be interposed between the chassis (1) and said rear wheel (3); and
a first hydraulic connection (6) connecting the front hydraulic cylinder (4) and the rear hydraulic cylinder (5), such that hydraulic fluid can pass from the front hydraulic cylinder (4) to the rear hydraulic cylinder (5), through said first hydraulic connection (6);
characterized in that the system additionally comprises:
a first compensation chamber (7) and a second compensation chamber (8) related to one another such that a change of volume ΔV1 of a hydraulic fluid in the first compensation chamber entails a change of volume ΔV2 of a hydraulic fluid in the second compensation chamber, ΔV2=k*ΔV1, k>0;
a second hydraulic connection (71) connecting the front hydraulic cylinder (4) and the first compensation chamber (7), such that the hydraulic fluid can pass from the front hydraulic cylinder (4) to the first compensation chamber (7) through said second hydraulic connection (71); and
a third hydraulic connection (81) connecting the rear hydraulic cylinder (5) and the second compensation chamber (8), such that hydraulic fluid can pass from the rear hydraulic cylinder (5) to the second compensation chamber, through said third hydraulic connection (81).

2. System according to claim 1, wherein one (7, 8) of said first compensation chamber (7) and second compensation chamber (8) is housed inside the other (8, 7) of said first compensation chamber (7) and second compensation chamber (8) (FIG. 14C).

3. System according to claim 2, wherein the cylinder (73, 83) of one of said compensation chambers (7, 8) is attached to the plunger (82, 72) of the other of said compensation chambers, such that the movement of said plunger entails the movement of said cylinder.

4. System according to claim 2, wherein said first compensation chamber (7) and second compensation chamber (8) are concentrically arranged.

5. System according to claim 1, wherein the first compensation chamber (7) comprises a first plunger (72) and wherein the second compensation chamber (8) comprises a second plunger (82), said first plunger (72) and second plunger (82) being attached to one another (10) such that the movement of one of said plungers (72, 82) entails the movement of the other of said plungers (82, 72).

6. System according to claim 1, wherein the first compensation chamber (7) and the second compensation chamber (8) are integrated in a front fork of the vehicle.

7. System according to claim 1 wherein one of said compensation chambers (7) is integrated in the front hydraulic cylinder (4) and/or one of said compensation chambers (8) is integrated in the rear hydraulic cylinder (5).

8. System according to claim 1, wherein both compensation chambers are integrated in a rear damper of the vehicle.

9. System according to claim 1, wherein the first compensation chamber (7) and the second compensation chamber (8) form a unit arranged outside a front fork of the vehicle and outside a rear suspension of the vehicle.

10. System according to claim 1, further comprising a valve (9) located in the first hydraulic connection (6) and in another hydraulic connection (71, 81), the valve being configured such that said valve controls the opening state of the other hydraulic connection (71, 81) depending on the difference between the pressure in a first part of the first hydraulic connection (6) and a second part of said first hydraulic connection (6).

11. System according to claim 1, further comprising a valve (9) located in the first hydraulic connection (6) and in another hydraulic connection (71, 81), the valve being configured such that said valve controls the opening state of the first hydraulic connection (6) depending on the difference between the pressure in a first part of the other hydraulic connection (71, 81) and a second part of said other hydraulic connection (71, 81).

12. Suspension system according to claim 10, wherein said valve (9) is configured for adopting a closed state when said pressure difference is below a predetermined level, and an open state when said pressure difference is above a predetermined level.

13. Suspension system according to claim 10, wherein said valve (9) is configured for adopting an open state with a degree of opening which increases with said pressure difference.

14. Suspension system according claim 10, wherein said valve (9) is configured such that it can adopt a closed state in which it prevents the passage of hydraulic fluid through one of the hydraulic connections (6; 71, 81) when hydraulic fluid does not pass through another of the hydraulic connections (71, 81;6).

15. Suspension system according to claim 14, wherein the valve (9) comprises a moveable piston (91) configured to enable adopting a blocking position in which it simultaneously blocks the flow of hydraulic fluid through the first hydraulic connection (6) and the flow hydraulic fluid through the other hydraulic connection (71, 81), and configured to be able to be moved, by a predetermined pressure difference in the first hydraulic connection (6), to an unblocking position in which it allows the flow of hydraulic fluid both through the first hydraulic connection (6) and through the other hydraulic connection (71, 81).

16. Suspension system according to claim 10, wherein said another hydraulic connection is the second hydraulic connection (71) or the third hydraulic connection (81).

17. System according to claim 10, wherein the said valve (9) is integrated in a front fork of the vehicle or in a rear damper of the vehicle.

18. System according to claim 1, additionally comprising a valve (R3′) located in an intake (41′) associated with the front hydraulic cylinder (4) and in an intake (51′) associated with the rear hydraulic cylinder (5), the valve being configured such that said valve controls the opening state of the first hydraulic connection (6) connecting the intake (41′) associated with the front hydraulic cylinder (4) and the intake (51′) associated with the rear hydraulic cylinder (5) depending on the sum of the pressure in the intake (41′) associated with the front hydraulic cylinder (4) and the pressure in the intake (51′) associated with the rear hydraulic cylinder (5).

19. Suspension system according to claim 18, wherein said valve (R3′) is configured for adopting a closed state when said sum of pressure is below a predetermined level, and an open state when said sum of pressure is above a predetermined level.

20. Suspension system according to claim 18, wherein said valve (R3′) is configured for adopting an open state with a degree of opening which increases with said sum of pressure.

21. Suspension system according to claim 18, wherein said valve (R3′) is configured such that it can adopt a closed state in which it prevents the passage of hydraulic fluid through the first hydraulic connection (6) connecting the intake (41′) associated with the front hydraulic cylinder (4) and the intake (51′) associated with the rear hydraulic cylinder (5) when hydraulic fluid does not pass between the intake (41″) associated with the front hydraulic cylinder (4) and the first compensation chamber (7) through the first hydraulic connection (71) and/or between the intake (51′) associated with the rear hydraulic cylinder (5) and the second compensation chamber (8) through the second hydraulic connection (81).

22. (canceled)
